(19) United States
(12) Patent Application Publication
(10) Pub. No.: US 2014/0009139 A1
(43) Pub. Date: Jan. 9, 2014

(54) DIFFERENTIAL CURRENT SOURCE AND DIFFERENTIAL CURRENT MIRROR CIRCUIT

(71) Applicant: FUJITSU LIMITED, Kawasaki-shi (JP)

(72) Inventor: Kazuaki OISHI, Yokohama (JP)

(73) Assignee: FUJITSU LIMITED, Kawasaki-shi (JP)

(21) Appl. No.: 14/026,938

(22) Filed: Sep. 13, 2013

Related U.S. Application Data
(63) Continuation of application No. PCT/JP2011/056420, filed on Mar. 17, 2011.

(51) Int. Cl. G05F 3/02

(52) U.S. Cl. CPC G05F 3/02
USPC 323/315; 323/312

(57) ABSTRACT

A differential current source includes two source transistors, sources of which are respectively connected to a power source, and a mixer circuit having a first terminal, a second terminal, a third terminal and a fourth terminal, the first terminal and the second terminal being respectively connected to drains of the two source transistors, and the third terminal and the fourth terminal being respectively output terminals, wherein the mixer circuit changes a connection state in accordance with a local signal between a first connection state where the first terminal and the third terminal are connected and also the second terminal and the fourth terminal are connected, and a second connection state where the first terminal and the fourth terminal are connected and also the second terminal and the third terminal are connected.

### CROSS-REFERENCE TO RELATED APPLICATION

This application is a continuation application of International Application PCT/JP2011/056420 filed on Mar. 17, 2011 and designated the U.S., the entire contents of which are incorporated herein by reference.

### FIELD

The disclosed techniques relate to a differential current source and a differential current mirror circuit.

### BACKGROUND

In an analog circuit, a current source is used widely.

FIG. 1A is a diagram illustrating a circuit diagram of a general current source that uses N-channel MOS (Nch) transistors and FIG. 1B is a diagram illustrating noise characteristics of the circuit in FIG. 1A.

FIG. 1A illustrates an example of a current source. The current source has a transistor Trs and a transistor Trc cascade-connected (connected in series). Trs and Trc are Nch transistors. The source of Trs is connected to a power source (here, ground) and the source of Trc is connected to the drain of Trs. To the gate of Trs, a predetermined voltage V1 is applied and to the gate of Trc, a predetermined voltage V2 is applied. The drain of Trc is an output terminal of the current source. The current source such as this is used widely as a current source of an analog circuit.

A current source in which a Pch transistor is used in place of an Nch transistor has been known. Hereinafter, a current source that uses an N-channel MOS (Nch) is explained as an example.

It has been known that 1/f noise occurs in the output of the current source formed by a MOS transistor as illustrated in FIG. 1B. In FIG. 1B, the broken line represents the 1/f noise in the case where the size of the MOS transistor is relatively large and the solid line represents the 1/f noise in the case where the size of the MOS transistor is relatively small.

In the case where a signal used in a circuit that uses the current source such as this is a low-frequency component, the 1/f noise becomes large at low frequencies, and therefore, the SN ratio is reduced. In general, the 1/f noise is generally in inverse proportion to the gate area of the transistor to the power of one half, and therefore, in order to reduce the 1/f noise, the size of the MOS transistor is increased. This leads to an increase in the chip area and to a rise in the cost. Because of this, there has been a demand for a current source having reduced the 1/f noise without increasing the size of the MOS transistor.

On the other hand, in the recent analog circuit, a differential circuit is the mainstream and, for example, in the circuit that uses a differential type OTA (Operational Transconductance Amplifier), a differential current source is used.

FIG. 2 is a circuit diagram of a general differential current source. As illustrated in FIG. 2, the differential current source has a first path for outputting a current Ip and a second path for outputting a current Im. The first path has two Nch transistors Tr1 and Tr1c cascade-connected, and the source of Tr1 is connected to a power source (here, ground) and the drain of Tr1c is one of output terminals of the differential current source. The second path has two Nch transistors Tr2 and Tr2c cascade-connected and the source of Tr2 is connected to a power source (here, ground) and the drain of Tr2c is the other output terminal of the differential current source. A bias circuit 10 generates a first bias voltage applied to the gates of Tr1 and Tr2 and a second bias voltage applied to the gates of Tr1c and Tr2c. In other words, the differential current source in FIG. 2 has a configuration in which two single-phase power sources in FIG. 1A are provided in parallel.

FIG. 3A to FIG. 3C are diagrams illustrating a use example of the differential current source, and FIG. 3A is a circuit diagram when in use, FIG. 3B illustrates voltages of input signals Inp and Inm of the circuit in FIG. 3A, and FIG. 3C illustrates currents of output signals Op and Om of the circuit in FIG. 3A. As illustrated in FIG. 3A, a low-potential side differential current source 100 has current sources 101 and 102 provided in parallel and a high-potential side differential current source 200 has current sources 201 and 202 provided in parallel. Between the current source 101 and the current source 201, a signal input transistor is connected, the positive side voltage signal Inp of the differential input signal is applied to the gate of the signal input transistor, and the negative side current signal Om of the differential output signal is obtained from the connection node of the signal input transistor and the current source 201. Between the current source 102 and the current source 202, a signal input transistor is connected, the negative side voltage signal Inm of the differential input signal is applied to the gate of the signal input transistor, and the positive side current signal Op of the differential output signal is obtained from the connection node of the signal input transistor and the current source 202.

As illustrated in FIG. 3B, the differential input signals Inp and Inm are differential voltage signals. As illustrated in FIG. 3C, the differential output signals Op and Om are differential current signals.

### RELATED DOCUMENTS

### [Patent Document 1] Japanese Laid Open Patent Document No. 07-221566

### [Patent Document 1] Japanese Laid Open Patent Document No. 2009-284429

### SUMMARY

According to an aspect of the embodiments, a differential current source includes: two source transistors, sources of which are respectively connected to a power source; and a mixer circuit having a first terminal, a second terminal, a third terminal and a fourth terminal, the first terminal and the second terminal being respectively connected to drains of the two source transistors, and the third terminal and the fourth terminal being respectively output terminals, wherein the mixer circuit changes a connection state in accordance with a local signal between a first connection state where the first terminal and the third terminal are connected and also the second terminal and the fourth terminal are connected, and a second connection state where the first terminal and the fourth terminal are connected and also the second terminal and the third terminal are connected.

According to another aspect of the embodiments, a differential current mirror circuit includes a mixer circuit having: two source transistors, sources of which are respectively connected to a power source; a first terminal and a second terminal respectively connected to drains of the two source transistors; and a third terminal and a fourth terminal, which are respectively output terminals, wherein the mixer circuit includes: a differential current source configured to change a connection state in accordance with a local signal between a first connection state where the first terminal and the third terminal are connected and also the second terminal and the fourth terminal are connected, and a second connection state where the first terminal and the fourth terminal are connected and also the second terminal and the third terminal are connected; two cascade transistors, ends of which are respectively connected to the third terminal and the fourth terminal, and the other ends of which respectively operate as output terminals of the differential current source; and two reference transistors, gates of which are connected in common to gates of the two cascade transistors, one of the two reference transistors is connected between a reference power source and the third terminal, and the other of the two reference transistors is connected between the reference power source and the fourth terminal.

The object and advantages of the embodiments will be realized and attained by means of the elements and combination particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1A is a diagram illustrating a circuit diagram of a general current source that uses N-channel MOS (Nch) transistors;

FIG. 1B is a diagram illustrating noise characteristics of the circuit in FIG. 1A;

FIG. 2 is a circuit diagram of a general differential current source;

FIG. 3A is a circuit diagram illustrating the differential current source in use;

FIG. 3B is a circuit diagram illustrating voltages of input signals Inp and Inm of the circuit in FIG. 3A;

FIG. 3C is a circuit diagram illustrating currents of output signals Op and Om of the circuit in FIG. 3A;

FIG. 4 is a circuit diagram of a differential current source of a first embodiment;

FIG. 5A and FIG. 5B are diagrams for explaining the operation of the differential current source of the first embodiment;

FIG. 6A is a diagram illustrating an equivalent circuit of the circuit in FIG. 5;

FIG. 6B and FIG. 6C are diagrams illustrating the noise characteristics of the equivalent circuit in FIG. 6A;

FIG. 7A and FIG. 7B are diagrams illustrating circuit configurations that can be thought of when the configuration described in JP07-221566A is applied to the differential current source;

FIG. 8 is a diagram illustrating the noise simulation result of both circuits when the differential current source of the first embodiment and the circuits in FIG. 7A and FIG. 7B are configured the same size, and P represents the case of the differential current source of the first embodiment and Q represents the case of the circuits in FIG. 7A and FIG. 7B;

FIG. 9 is a diagram illustrating a use example of the differential current source of the first embodiment;

FIG. 10 is a circuit diagram of a differential current source of a second embodiment;

FIG. 11 is a circuit diagram of a differential current source of a third embodiment;

FIG. 12 is a circuit diagram of a differential current source of a fourth embodiment;

FIG. 13A is a circuit diagram of a differential current mirror circuit of a fifth embodiment;

FIG. 13B is a diagram illustrating a configuration of a general loop-back cascade type current mirror circuit.

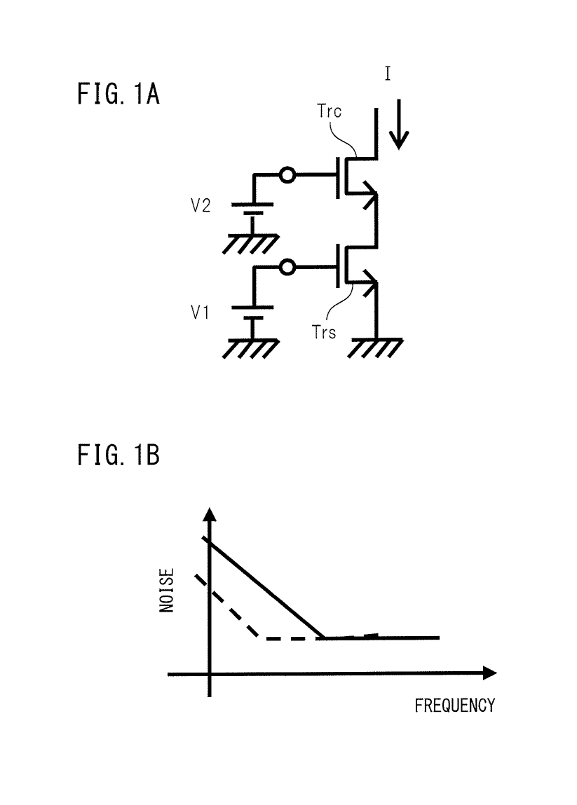

### DESCRIPTION OF EMBODIMENTS

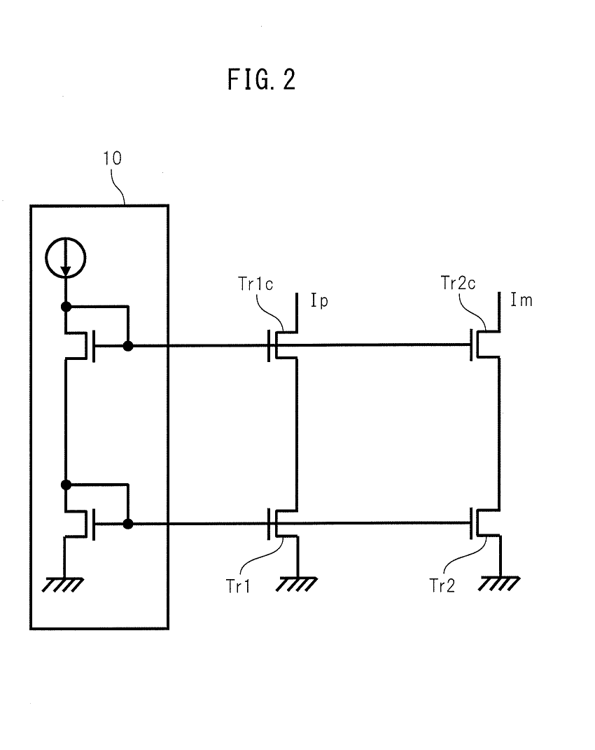

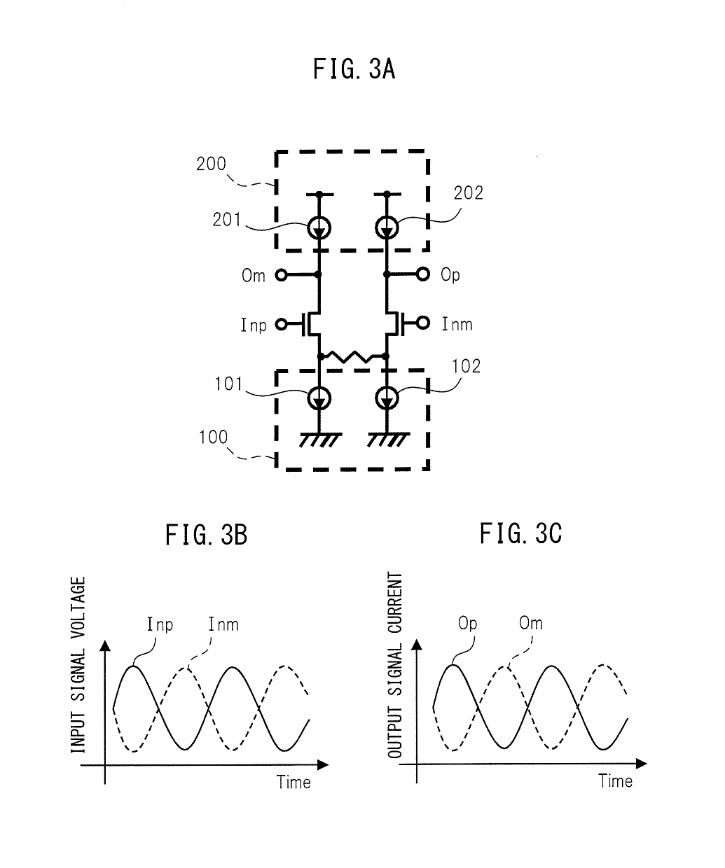

As illustrated in FIG. 2, the differential current source has a configuration similar to that of the single-phase current source and the 1/f noise resulting from the MOS transistor occurs. Because of this, there has been a demand for a differential current source having reduced the 1/f noise without increasing the size of the MOS transistor. According to the embodiments, a differential current source in which the 1/f noise is reduced without increasing the size of the MOS transistor.

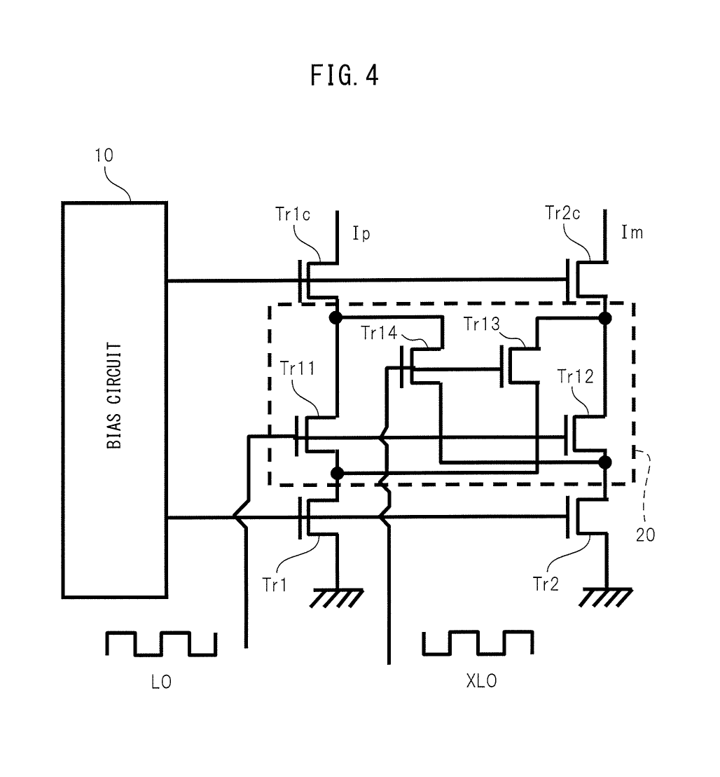

FIG. 4 is a circuit diagram of a differential current source of a first embodiment. The differential current source of the first embodiment is a low-potential side differential current source.

The differential current source of the first embodiment has the first source transistor Tr1, the second source transistor Tr2, a mixer circuit 20, the first cascade transistor Tr1c and the second cascade transistor Tr2c the sources of which are connected to the mixer circuit 20, and a bias circuit 10. An example of the bias circuit 10 has the same configuration as that of the bias circuit illustrated in FIG. 2.

The first and the second transistor Tr1 and Tr2 are Nch transistors and the sources of which are connected to the low-potential side power source (ground).

The mixer circuit 20 has a first terminal connected to the drain of Tr1, a second terminal connected to the drain of Tr2, a third terminal connected to the source of Tr1c, and a fourth terminal connected to the source of Tr2c. The mixer circuit 20 has a first transistor Tr11 connected between the first terminal and the third terminal, a second transistor Tr12 connected between the second terminal and the fourth terminal, a third transistor Tr13 connected between the first terminal and the fourth terminal, and a fourth transistor Tr14 connected between the second terminal and the third terminal. Tr11 to Tr14 are Nch transistors.

To the gates of the first transistor Tr11 and the second transistor Tr12, a signal LO, which is one of differential local signals, is applied. To the gates of the third transistor Tr13 and the fourth transistor Tr14, a signal XLO, which is the other differential local signal, is applied. Due to this, Tr11 and Tr12 operate in the opposite phase of Tr13 and Tr14. In other words, when Tr11 and Tr12 are in the on state (in conduction), Tr13 and Tr14 are in the off state (out of conduction) and when Tr11 and Tr12 are in the off state, Tr13 and Tr14 are in the on state.

It is desirable for the differential local signal to have a frequency higher than a frequency range, which is the target of a circuit that uses the differential current source of the first embodiment.

The first cascade transistor Tr1c is an Nch transistor and the source of which is connected to the third terminal of the mixer circuit 20 and the drain of which functions as an output terminal of the differential current source. The second cascade transistor Tr2c is an Nch transistor and the source of which is connected to the fourth terminal of the mixer circuit 20 and the drain of which functions as an output terminal of the differential current source.

As described above, the differential current source of the first embodiment has a configuration in which the normally cascade-connected current sources are provided in parallel and the mixer circuit 20 is inserted between the two source transistors and the two cascade transistors. The mixer circuit 20 is driven by the local signals LO and XLO having frequencies higher than the used signal band.

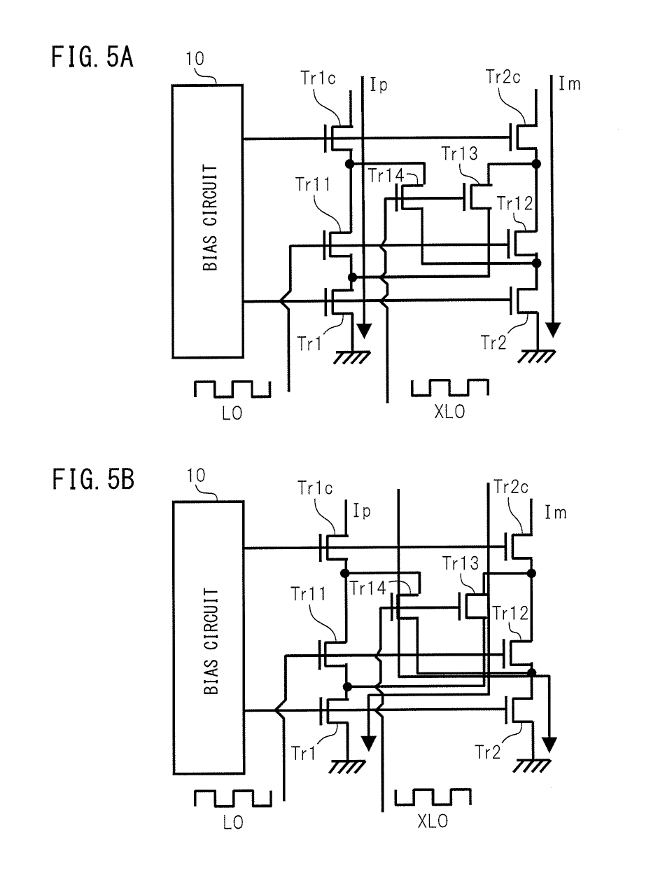

FIG. 5A and FIG. 5B are diagrams for explaining the operation of the differential current source of the first embodiment.

When the signal LO, which is one of the local signals, is at “H” and the other signal XLO is at “L”, Tr11 and Tr12 enter the on state and Tr13 and Tr14 enter the off state as illustrated in FIG. 5A. Due to this, a path passing through Tr1, Tr11, and Trio is formed and the current of Tr1 is output as the output current Ip. At the same time, a path passing through Tr2, Tr12, and Tr2c is formed and the current of Tr2 is output as the output current Im.

Next, when LO is at “L” and the other signal XLO is at “H”, Tr11 and Tr12 enter the off state and Tr13 and Tr14 enter the on state as illustrated in FIG. 5B. Due to this, a path passing through Tr1, Tr13, and Tr2c is formed and the current of Tr1 is output as the output current Im. At the same time, a path passing through Tr2, Tr14, and Tr1c is formed and the current of Tr2 is output as the output current Ip.

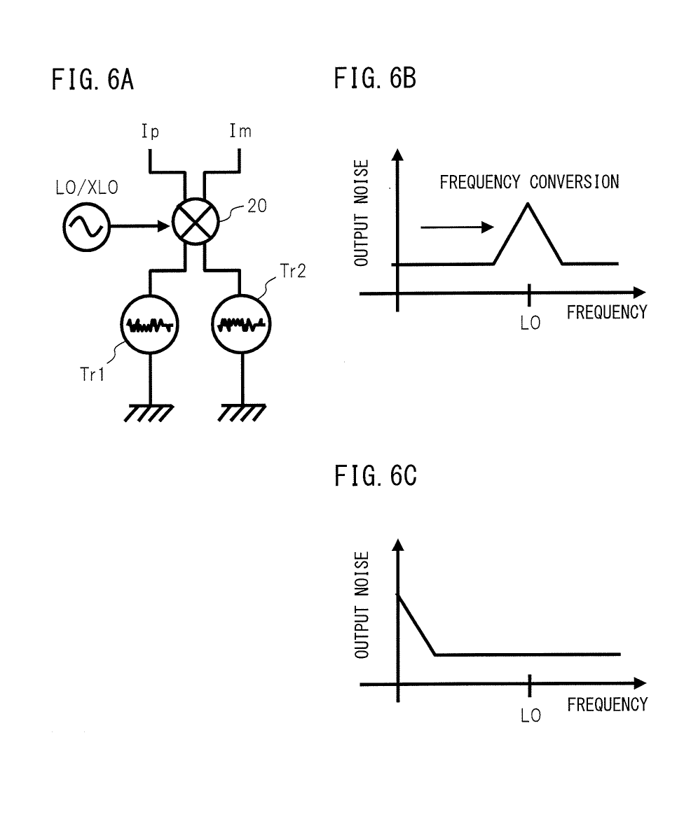

FIG. 6A is a diagram illustrating an equivalent circuit of the circuit in FIG. 5. FIG. 6B and FIG. 6C are diagrams illustrating the noise characteristics of the equivalent circuit in FIG. 6A.

In the circuit in FIG. 5, due to the polarities of the local signals, the currents of Tr1 and Tr2 are exchanged and output. This is expressed by the equivalent circuit as in FIG. 6A. The noise generated from Tr1 and Tr2 is output as Ip and Im through the mixer circuit 20 as a result. Consequently, the 1/f noise in the low-frequency region illustrated in FIG. 6C generated from Tr1 and Tr2 is converted so as to have the frequency of the local signals LO and XLO and shifted toward the high-frequency side as illustrated in FIG. 6B. Due to this, the 1/f noise is reduced in the low-frequency region, and therefore, the SN ratio of the low-frequency signal is improved. The noise is converted so as to have a high frequency beyond the signal band, and therefore, the SN ratio is not reduced.

JP07-221566A describes a current mirror circuit having reduced the influence of the difference in the threshold voltage of the transistor by switching the connections in two paths, i.e., a reference path and an operation path, of the current mirror circuit by a specified frequency.

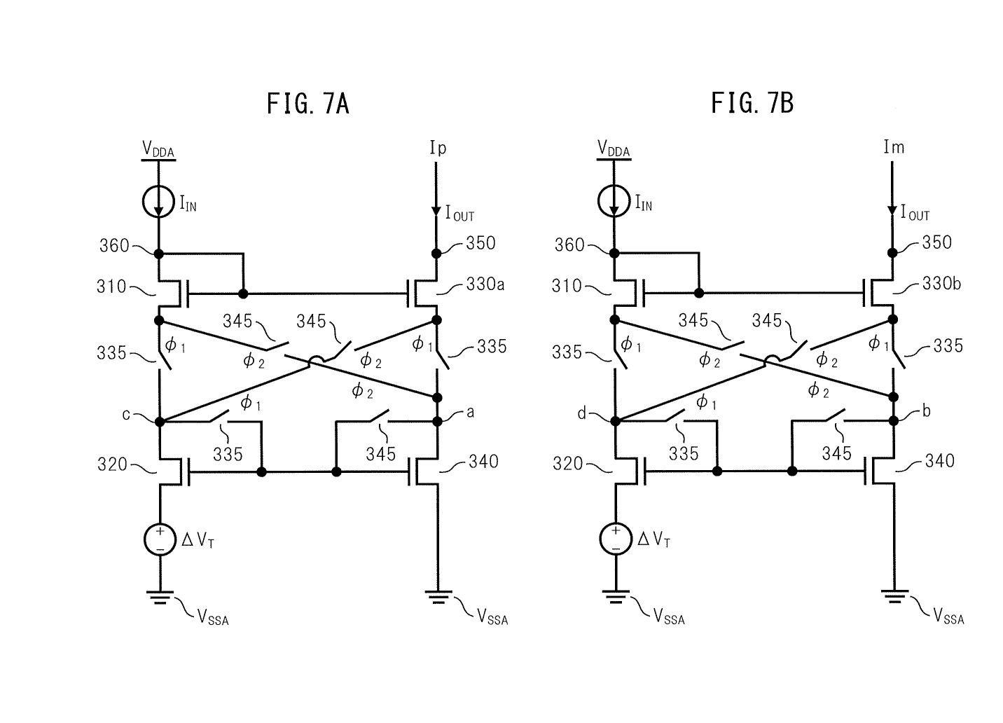

FIG. 7A and FIG. 7B are diagrams illustrating circuit configurations that can be thought of when the configuration described in JP07-221566A is applied to the differential current source. The two paths of the differential current source are the operation paths, and therefore, it can be thought of that the connections are respectively switched by handling the two paths as a dual path. Because of this, an increase in the number of elements will result.

In contrast to the above, in the differential current source of the first embodiment, the two paths are the operation paths, however, the fact that the connections thereof can be switched is focused on, and switching of connections in the differential current source is realized with a small number of elements.

For example, when a mixer circuit is provided, which switches connections by respectively handling the two paths of the differential current source as a dual path, by applying the configuration described in JP07-221566A as illustrated in FIG. 7A and FIG. 7B, six switch transistors are used in the mixer circuit. That is, six transistors are used for one of the differential current sources. In contrast, in the first embodiment, the mixer circuit of the differential current source is configured by four transistors and one of the differential current sources can be configured by two transistors.

Further, the circuits illustrated in FIG. 7A and FIG. 7B have such a problem that the noise generated from a cascade transistor 330 is added to the output current and the noise increases. This results from the operations as follows.

Potentials at a and c deviate due to the noise generated in Tr 330a.
Current I_noise_a resulting from the potential difference occurs in each switching period.
Between b and d also, the potential difference relating to the noise generated in Tr 330b occurs.
Current I_noise_b resulting from the potential difference occurs in each switching period.
Because I_noise_a and I_noise_b are current values of different current paths, as Ip and Im, the differential noise currents resulting from Tr 330a and Tr 330b are output. In other words, when the two paths of the differential current source are respectively handled as a dual path, the frequency conversion of the noise by switching connections is respectively performed in the independent dual paths.

In contrast to the above, in the differential current source of the first embodiment, at the connection node of Tr1, Tr11, and Tr13, the potential resulting from the nose of Tr2c occurs and at the connection node of Tr2, Tr12, and Tr14, the potential resulting from the noise of Tr1 occurs. However, as both Ip and Im, the noise current in the same amount resulting from the potential difference between the above-mentioned two nodes is output, and therefore, the low-frequency differential current resulting from the noise of Tr1c and Trc2 does not occur.

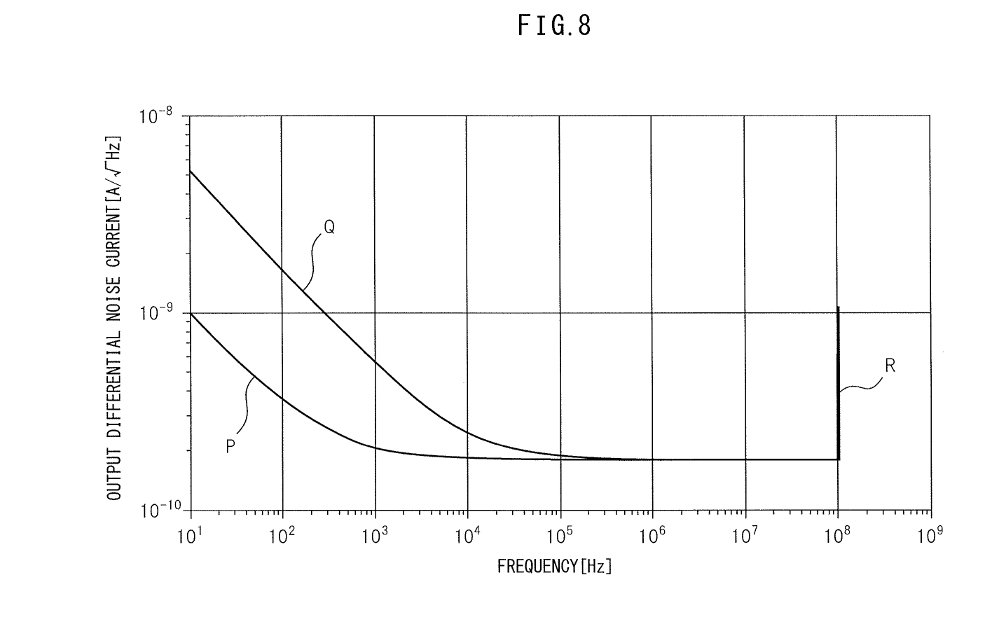

FIG. 8 is a diagram illustrating the noise simulation result of both circuits when the differential current source of the first embodiment and the circuits in FIG. 7A and FIG. 7B are configured the same size, and P represents the case of the differential current source of the first embodiment and Q represents the case of the circuits in FIG. 7A and FIG. 7B. In FIG. 8, R represents the noise subjected to frequency conversion that appears in the switching frequency in the differential current source of the first embodiment. From FIG. 8, it is known that the 1/f noise is reduced in the low-frequency region.

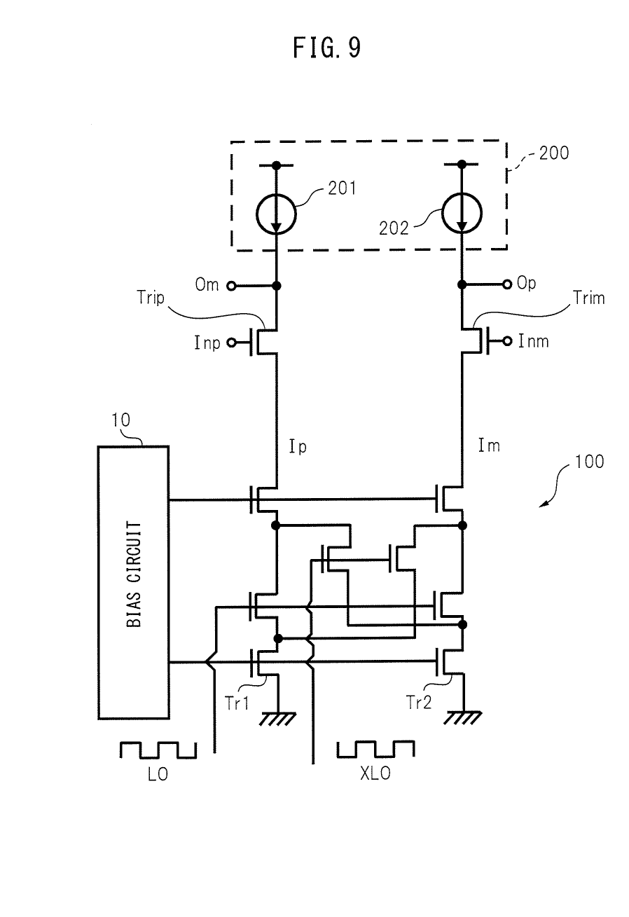

FIG. 9 is a diagram illustrating a use example of the differential current source of the first embodiment. The portion denoted by reference numeral 100 is the differential current source of the first embodiment that works as the low-potential side differential current source and 200 denotes the high-potential side differential current source, and signal input transistors Trip and Trim are connected therebetween. To the gate of Trip, Inp, which is one of differential input signals, is applied and to the gate of Trim, Inm, which is the other differential input signal, is applied. The output Om is output from the connection node of the current source 201, which is one of the high-potential side differential current sources, and Trip, and the output Op is output from the connection node of the current source 202, which is the other high-potential side differential current source, and Trim.

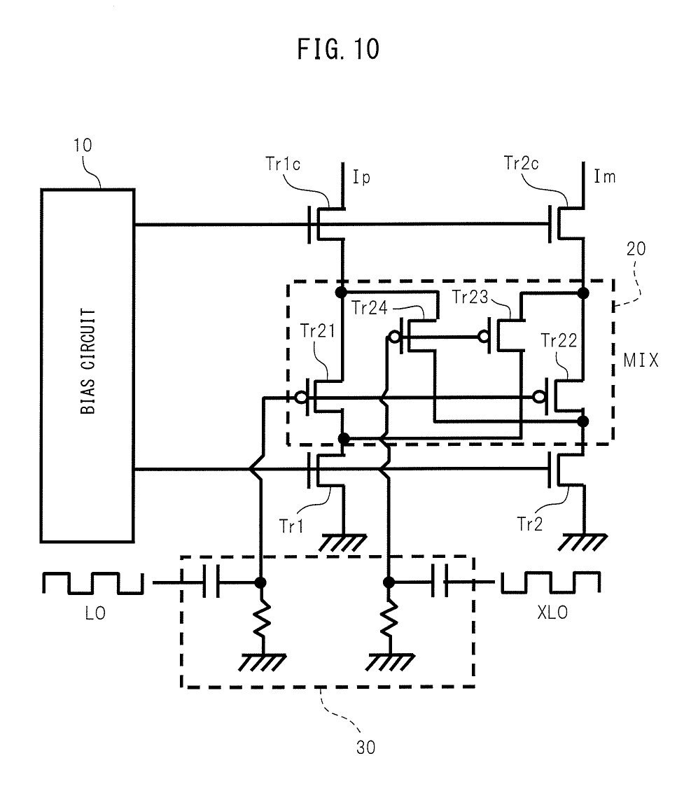

FIG. 10 is a circuit diagram of a differential current source of a second embodiment.

The differential current source of the second embodiment differs from that of the first embodiment in that Pch transistors Tr21 to Tr24 are used as the transistors of the mixer circuit 20 of the first embodiment and the differential local signals LO and XLO are applied to Tr21 to Tr24 via a high-pass filter 30. The high-pass filter 30 has two resistors connected between the gates of Tr21 and Tr22, and the ground, and between the gates of Tr23 and Tr24, and the ground, and two capacitors connected to the connection node of the gates of Tr21 and Tr22, and the resistor, and the connection node of the gates of Tr23 and Tr24, and the resistor. The differential local signals LO and XLO are respectively supplied via the two capacitors.

In the differential current source of the first embodiment, the 1/f noise occurs mainly in Tr1 and Tr2, and also occurs to a certain extent in the four Nch transistors Tr11 to Tr14 of the mixer circuit 20, resulting in an increase in noise. It is known that the 1/f noise that occurs in the Nch transistor is generally larger than the 1/f noise that occurs in the Pch transistor. Consequently, in the second embodiment, the Pch transistors Tr21 to Tr24 are used as the transistors of the mixer circuit 20 to suppress the occurrence of noise.

Because of this, in the differential current source of the second embodiment, noise is further reduced compared to the differential current source of the first embodiment.

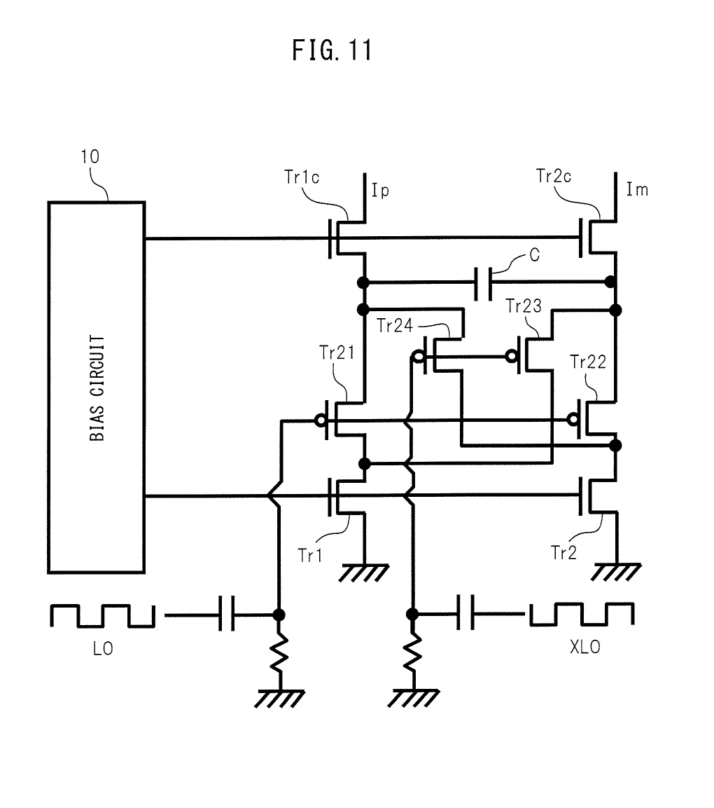

FIG. 11 is a circuit diagram of a differential current source of a third embodiment.

The differential current source of the third embodiment differs from that of the second embodiment in that a capacitor C is connected between the third terminal and the fourth terminal of the mixer circuit 20, i.e., between the connection node of Tr21, Tr24, and Tr1c and the connection node of Tr22, Tr23, and Tr2c. By providing the capacitor C, it is possible to reduce the switching noise (local leak) from the mixer circuit.

The configuration of the third embodiment in which the capacitor C is provided is also effective similarly in the first embodiment. The differential current sources of the first to third embodiments are the low-potential side differential current sources, however, the configuration thereof can also be applied to the high-potential side differential current source similarly.

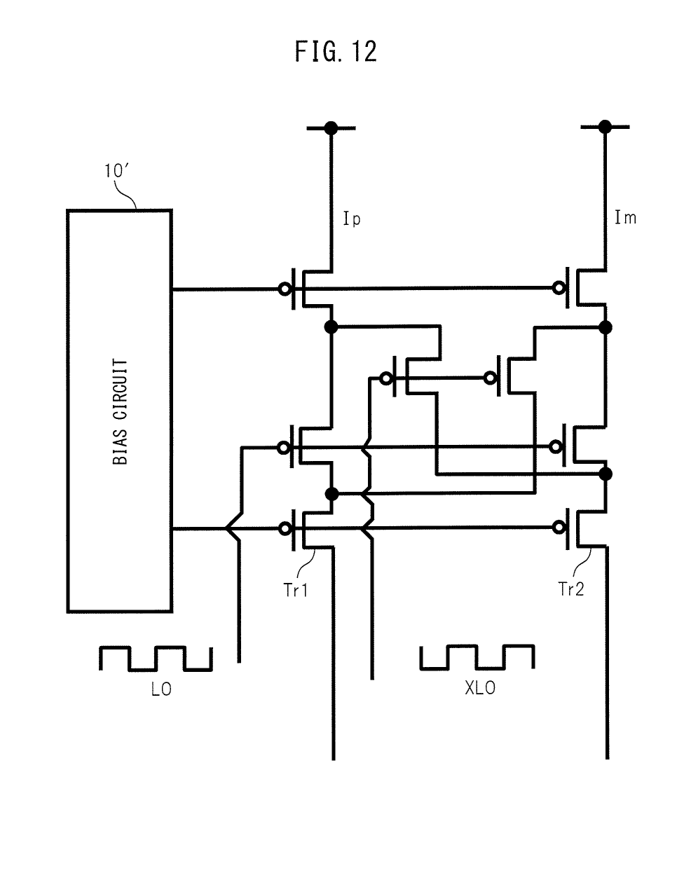

FIG. 12 is a circuit diagram of a differential current source of a fourth embodiment. The differential current source of the fourth embodiment is the high-potential side differential current source. The differential current source of the fourth embodiment differs from the differential current source of the first embodiment in FIG. 4 in that the transistors Tr1, Tr2, Tr11 to Tr14, Tr1c, and Tr2c are changed from the Nch transistor to the Pch transistor. A bias circuit 10′ generates a voltage adapted to the Pch transistor.

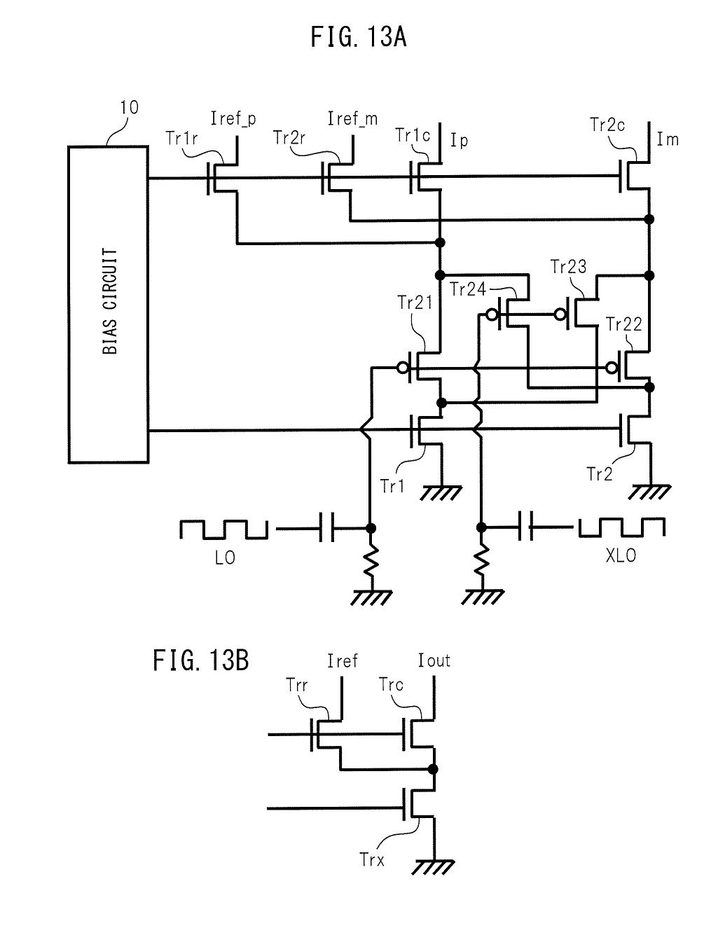

FIG. 13A is a circuit diagram of a differential current mirror circuit of a fifth embodiment. FIG. 13B is a diagram illustrating a configuration of a general folded cascade type current mirror circuit.

As illustrated in FIG. 13B, the current mirror circuit on the low-potential side has a common transistor Trx, a reference path transistor Trr, and an operation path transistor Trc. The common transistor Trx is an Nch transistor and the source of which is connected to the ground. The reference path transistor Trr is an Nch transistor and the source of which is connected to the drain of Trx and the drain of which is connected to a reference current path. The reference current path is connected to a reference current source. The operation path transistor Trc is an Nch transistor and the source of which is connected to the drain of Trx, the drain of which is connected to the operation path, and a current is output.

The differential current mirror circuit of the fifth embodiment differs from the differential current source of the second embodiment in that reference path transistors Tr1r and Tr2r are provided in parallel to the cathode transistors Tr1c and Tr2c. To the gates of the reference path transistors Tr1r and Tr2r, the voltage generated in the bias circuit 10 and to be applied to the gates of the cathode transistors Tr1c and Tr2c is applied in common. The reference path transistor Tr1r is connected between the first reference path and the connection node of Tr1c and the third terminal (Tr21 and Tr24). The reference path transistor Tr2r is connected between the second reference path and the connection node of Tr2c and the fourth terminal (Tr22 and Tr23). Through the first reference path, a first reference current Iref_p flows and through the second reference path, a second reference current Iref_m flows. The first reference path to which Tr1r is connected and the path to which the drain of Tr1c is connected form the current mirror circuit, and Iref_p and Ip build a relationship of current mirror signals. The second reference path to which Tr2r is connected and the path to which the drain of Tr2c is connected form the current mirror circuit and Iref_m and Im build a relationship of current mirror signals.

By using the differential current mirror circuit of the fifth embodiment in FIG. 13A, it is possible to configure a current mirror circuit with low 1/f noise.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A differential current source comprising:
two source transistors, sources of which are respectively connected to a power source; and
a mixer circuit having a first terminal, a second terminal, a third terminal and a fourth terminal, the first terminal and the second terminal being respectively connected to drains of the two source transistors, and the third terminal and the fourth terminal being respectively output terminals, wherein
the mixer circuit changes a connection state in accordance with a local signal between a first connection state where the first terminal and the third terminal are connected and also the second terminal and the fourth terminal are connected, and a second connection state where the first terminal and the fourth terminal are connected and also the second terminal and the third terminal are connected.

2. The differential current source according to claim 1, comprising two cascade transistors, ends of which are respectively connected to the third terminal and the fourth terminal, and the other ends of which respectively operate as output terminals of the differential current source.

3. The differential current source according to claim 1, wherein
the mixer circuit includes:
a first transistor connected between the first terminal and the third terminal;
a second transistor connected between the second terminal and the fourth terminal;
a third transistor connected between the first terminal and the fourth terminal; and
a fourth transistor connected between the second terminal and the third terminal,
the local signal includes differential local signals,
one of the differential local signals is applied to the gates of the first transistor and the second transistor, and
the other differential local signal is applied to the gates of the third transistor and the fourth transistor.

4. The differential current source according to claim 3, wherein
the differential local signals are applied to the gates of the first to fourth transistors via a high-pass filter including a resistor and a capacitor.

5. The differential current source according to claim 1, wherein
the first to fourth transistors of the mixer circuit are transistors having the same polarity as that of the two source transistors.

6. The differential current source according to claim 1, wherein
the first to fourth transistors of the mixer circuit are transistors the polarity of which is different from that of the two source transistors.

7. The differential current source according to claim 1, comprising a capacitor connected between the third terminal and the fourth terminal.

8. The differential current source according to claim 5, wherein
the two source transistors and the first to fourth transistors of the mixer circuit are N channel transistors.

9. The differential current source according to claim 6, wherein
the two source transistors are N channel transistors and the first to fourth transistors of the mixer circuit are P channel transistors.

10. A differential current mirror circuit comprising a mixer circuit having:
two source transistors, sources of which are respectively connected to a power source;
a first terminal and a second terminal respectively connected to drains of the two source transistors; and
a third terminal and a fourth terminal, which are respectively output terminals, wherein
the mixer circuit includes:
a differential current source configured to change a connection state in accordance with a local signal between a first connection state where the first terminal and the third terminal are connected and also the second terminal and the fourth terminal are connected, and a second connection state where the first terminal and the fourth terminal are connected and also the second terminal and the third terminal are connected;
two cascade transistors, ends of which are respectively connected to the third terminal and the fourth terminal, and the other ends of which respectively operate as output terminals of the differential current source; and
two reference transistors, gates of which are connected in common to gates of the two cascade transistors,
one of the two reference transistors is connected between a reference power source and the third terminal, and
the other of the two reference transistors is connected between the reference power source and the fourth terminal.
